(19) United States
(12) Patent Application Publication
(10) Pub. No.: US 2022/0048303 A1
(43) Pub. Date: Feb. 17, 2022

(54) METHODS OF CHANGING COLOR OF SURFACE-FORMING PORTIONS

(71) Applicant: Michio KOIBUCHI, TOKYO (JP)

(72) Inventor: Michio KOIBUCHI, TOKYO (JP)

(21) Appl. No.: 17/433,920

(22) PCT Filed: Feb. 19, 2020
(86) PCT No.: PCT/JP2020/006388

§ 371 Date: Aug. 25, 2021

(30) Foreign Application Priority Data
Feb. 27, 2019 (JP) 2019-033642

(51) Int. Cl. B41M 1/14; C09K 9/02; A45D 29/00; A45D 19/00; B05D 5/06

(52) U.S. Cl. CPC B41M 1/14; C09K 9/02; B05D 5/065; A45D 19/00; A45D 29/00

(57) ABSTRACT

To deposit a photochromic substance 3 on a surface-forming portion 1 of an object; and, when light in an ultraviolet range 5 is projected onto the surface of the deposited photochromic substance 3 to change the color of the photochromic substance 3 by photochromism, cover the deposited photochromic substance 3 with a wavelength-cutoff agent 4 that blocks wavelengths in an ultraviolet spectrum contained in natural light and/or illumination light.

### CROSS-REFERENCE TO RELATED APPLICATIONS

This application is a U.S. National Stage Application filed under 35 U.S.C. § 371 of PCT/JP2020/006388, filed Feb. 19, 2020, and entitled METHODS OF CHANGING COLOR OF SURFACE-FORMING PORTIONS, which International Application claims the benefit of priority from Japanese Patent Application No. 2019-033642, filed on Feb. 27, 2019. The entire contents of each of the above-identified patent applications are incorporated herein by reference.

### TECHNICAL FIELD

The present invention relates to methods of reversibly changing the color of a part of or the entire surface (hereinafter, referred to as a “surface-forming portion”) of an object having the surface, using a photochromic compound and light with wavelengths that induce photochromism of the photochromic compound.

### BACKGROUND ART

Conventionally, a technique for coloring the surface of objects having the surface, such as nails (including artificial nails; the same applies hereinafter) or bags, using electrochromism has been known from, for example, Patent Documents 1 and 2.

For organic electrochromic compounds, vivid color reactions for CMY (cyan, magenta, and yellow) have won success in being controlled electrically. These compounds, however, revert to their original color in a short time once the charge is removed. Hybrid (mixed) organic/inorganic electrochromic compounds are also under development. Still, they are similar to known electrochromic materials in that the colored state lasts for only a certain time after the removal of the charge and the color is restored. For this reason, these compounds are not suitable for use in applications involving changing the color of products (objects) and keeping this state for a long time. In addition, color changes of a surface-forming portion using a known electrochromic compound inevitably require an electrical system including a power supply due to electrical control of the color reactions, unfortunately lacking the versatility in this respect.

A phenomenon that a reversible transformation of a single compound between two isomers (A and B) of different colors without changing its molecular weight upon irradiation with light is known as photochromism. Photochromic materials that undergo photochromism are compounds that reversibly change their color upon irradiation with light with specific wavelengths. Among them, “solid-state multicolor photochromism” based on silver compounds is a reversible phenomenon in which solids change their color, upon irradiation with light with specific wavelengths, to a color corresponding to the wavelengths of the irradiated light and revert to their original color when irradiated with light other than ultraviolet.

There is a photochromic single-crystal (mixed crystal) compound prepared by incorporating three different compounds that undergo respective color changes from colorless to blue (1a), red (2a), and yellow (3a) when exposed to light with their appropriate wavelengths, in which the three compounds are very similar in their chemical structure but are different in the molecular state. This photochromic compound exhibits blue, red, and yellow colors upon irradiation with light with specific wavelengths. Polarized absorption spectrum analysis has demonstrated that the photochromic reaction (photochromism) of these three components still proceeds in the crystalline state. The photochromic compound indicated is single-crystal diarylethene, which can exhibit multicolor photochromism, i.e., reversible changes into various colors even in the single crystal. Note that the photochromic reaction of diarylethene is characterized by causing color changes in response to a narrow band of wavelengths in the ultraviolet spectrum, and each induced color tends to revert to the original color by wavelengths in the visible spectrum.

On the other hand, in the field of photo-sensitive materials for photographs such as silver halide color photographs (e.g., silver halide photo-sensitive materials), improving the light fastness of the materials has been an issue. Accordingly, the decrease in density (photochromism=photochromic reaction) due to exposure to light such as natural light is considered as a negative phenomenon, and various studies and developments have been made to suppress this phenomenon. By way of example, wavelength-cutoff agents that can block specific wavelengths, manufactured by Fujifilm Corporation, are commercially available under the trade name “COMFOGUARD” as specific-wavelength-cutoff agents capable of selectively cutting off specific unwanted wavelengths to prevent color fading and provide color reproducibility of silver halide photographs. This wavelength-cutoff agent allows users to tune the wavelengths of light to be cut off in 20 nm increments, and if necessary, freely choose the cut-off wavelengths in the region between ultraviolet and infrared.

The inventor of the present invention concentrated on a photochromic material's property that the photochromic compounds containing diarylethene mentioned above change their color reversibly in response to light in a specific band, as well as the function of the wavelength-cutoff agents which can cut off any wavelength in the region spanning from ultraviolet to infrared. The inventor then obtained findings that the color of the photochromic material that has changed to the desired color can be maintained for a required time under natural light by using a wavelength-cutoff agent that cuts off wavelengths in the desired band.

The color of an object having a surface covered with a specific photochromic compound can be converted to the desired color by exposing the object to light with specific wavelengths in the ultraviolet spectrum, which induce photochromism. Covering the object's surface with a wavelength-cutoff agent that blocks wavelengths in the ultraviolet spectrum of natural light to maintain the induced color allows the induced color to be maintained for a required time and prevents it from fading.

The inventor of the present invention further concentrated on a diarylethene's property that it is more susceptible to the ultraviolet wavelengths but not to the visible wavelengths, and obtained findings that the wavelengths in the ultraviolet spectrum of natural light can be blocked and that the induced color can be maintained for a certain time, by means of: covering the surface of the object (the surface-forming portion of a product) with diarylethene; exposing the surface of the diarylethene to light in the ultraviolet range to convert the color of the diarylethene to the desired color; and then coating the surface-forming portion with a wavelength-cutoff agent that cuts off wavelengths in the ultraviolet spectrum of natural light.

### RELATED ART DOCUMENT

### Patent Document

Patent document 1: JP-A-2017-153784
Patent document 2: JP-A-2018-187106

### SUMMARY OF INVENTION

### Technical Problem

A first object of the present invention is to provide a color-changing method comprising: covering a part of or the entire surface of an object (hereinafter, referred to as a “surface-forming portion”) with a photochromic substance (hereinafter, also referred to as a “photochromic compound” or a “photochromic material”); exposing the surface-forming portion to light with specific wavelengths to change the color of the surface-forming portion; and exposing the color-changed surface-forming portion to light (wavelengths) other than the specific wavelengths to restore the original color.

A second object of the present invention is to provide a method with which the color of the surface-forming portion can be changed to an intended color (desired color) using the photochromic property of diarylethene, and then the induced color can be maintained for a certain time.

### Solution to Problem

The configuration of a first invention made for the purpose of achieving the first object mentioned above, comprising depositing a photochromic substance on a surface-forming portion of an object by, for example, spreading the substance, and then exposing the surface of the deposited photochromic substance to light in an ultraviolet spectrum to change the color of the photochromic substance by photochromism. In irradiating the light in the ultraviolet range, the surface may be covered with a wavelength-cutoff agent that blocks wavelengths of illumination light and/or natural light, including ultraviolet radiation.

The configuration of a second invention which can achieve the second object mentioned above is characterized by comprising: depositing diarylethene as a photochromic substance on a surface-forming portion of an object by, for example, spreading the substance; exposing the surface of the deposited diarylethene to light with specific wavelengths to change the color of the diarylethene to the desired color; and then covering the color-changed surface with a wavelength-cutoff agent that blocks wavelengths in the ultraviolet spectrum of natural light and/or illumination light, thereby keeping the color-changed state for a certain time.

Hereafter, “the present invention” as used herein refers to a concept that includes the first and second inventions described above.

An example of the photochromic substance to be deposited on the surface-forming portion is an organic photochromic compound that changes its color to a color in the visible region corresponding to the specific wavelengths upon irradiation with light with the specific wavelengths. This organic photochromic compound is, for example, single-crystal diarylethene comprising organic molecules with three different structures. The indicated diarylethene exhibits red, yellow, and blue colors by light at 370 nm, 380 nm, and 405 nm light, respectively, in the ultraviolet region, and each induced color reverts to the original color by light with 450 nm or longer wavelengths in the visible region. The wavelengths of light at 370 nm, 380 nm, and 380 nm mentioned above fall within the ultraviolet region, but the bands are near the visible region.

In the present invention, inorganic photochromic compounds, such as titanium dioxide loaded with Ag nanoparticles, can be used as photochromic substances.

Inorganic photochromic compounds can be used to change the color of the surface-forming portion of an object by: depositing one on the surface-forming portion of the object; then exposing the surface of the deposited photochromic material to light with wavelengths of any color (desired color) in the visible region to change the color of the surface-forming portion to the color of the irradiated light (desired color); and covering the color-changed surface with a wavelength-cutoff agent that blocks wavelengths of natural light, including ultraviolet radiation.

Upon irradiation with light with specific wavelengths in the visible spectrum, inorganic photochromic compounds develop color corresponding to it. Thus, the wavelength-cutoff agent used for being pre-coated on the surface of an inorganic photochromic compound is the one that cuts off wavelengths of natural light, including ultraviolet radiation, other than the light with specific wavelengths in the visible spectrum irradiated for the color change.

The surface-forming portions to which the present invention can be applied include the entire or a part of the surface-forming portion of any of the following having a colored surface: nails, artificial nails, lips, hair on one's body including hair on one's head, eyeglasses, watches, jewelry including rings, bracelets, and necklaces (hereinafter referred to as “jewelry”), bags, shoes, textiles including neckties, scarves, and handkerchiefs, natural and synthetic fibers, bodies of vehicles including motorcycles and cars, wall materials, indoor equipment including pieces of furniture, outdoor equipment including signboards, and wall surfaces including ceilings, floors, and side walls of buildings.

In the implementation of the first invention, a surface-forming portion of an object on which a photochromic material has been deposited is prepared, and light-emitting means configured to emit light with wavelengths whose range can be arbitrarily determined for the surface-forming portion is prepared. Then, light with specific wavelengths in, for example, the ultraviolet spectrum is projected from the light-emitting means to the surface-forming portion to induce photochromism of the photochromic substance, thereby changing the color of the surface-forming portion to the desired color.

In the implementation of the second invention, diarylethene is prepared as a photochromic substance. This is deposited on the surface-forming portion of the object by, for example, coating, and the surface of the deposited diarylethene is exposed to light with specific wavelengths in the ultraviolet spectrum to change the diarylethene to the desired color. When the surface that has changed to the desired color is covered with a wavelength-cutoff agent that blocks specific wavelengths in the ultraviolet spectrum, the color of the color-changed surface can be maintained for a certain time.

The aforementioned photochromic substance is an organic photochromic compound, diarylethene being example. It has a property of changing the color, upon irradiation with light with specific wavelengths in the ultraviolet spectrum, to a color in the visible light region corresponding to the specific wavelengths irradiated and reverts to its original color upon irradiation with light with 450 nm or longer wavelengths in the visible spectrum.

The aforementioned diarylethene has the property of photochromism (change in color in the forward direction) that occurs under the influence of light with wavelengths in the ultraviolet spectrum and photochromism (change in color in the reverse direction) in which the color-changed surface returns to its original color in response to the light with wavelengths in the visible spectrum. Thus, by making the forward and the reverse color-changing vectors compete with each other using a wavelength-cutoff agent for the ultraviolet, it is possible to prevent the induced desired color from fading.

The light-emitting means can be any device capable of emitting light with specific wavelengths chosen randomly from the ultraviolet to infrared range. The wavelength-cutoff agent that cuts off the specific wavelengths used should allow users to tune the wavelengths to be cut off in 20 nm increments and block them.

The method of changing the color of the surface-forming portion according to the present invention can be applied to three-dimensional objects, such as car bodies, as a new exterior decoration method for the surface-forming portion that replaces conventional decoration methods such as painting and wrapping. An example of the specific method is as follows.

According to the first invention, a photochromic compound is applied to the outer surface of a 3D object, such as a car body. A 3D scanner scans the surface of the applied layer to obtain 3D scan data for modeling and analyzing the object's shape. Then, the analyzed object is mapped with a pre-selected graphic pattern. The mapped object is irradiated with light with specific wavelengths in the ultraviolet spectrum during or after the mapping to change the color of the photochromic compound that has applied to the object. A graphic pattern is applied to a 3D object in this way, and the color of the object can be changed to the desired color. The generated color can be reversed by irradiating light at 450 nm or longer in the visible spectrum.

In the second invention, a photochromic compound is applied to the outer surface of a 3D object. A 3D scanner scans the 3D object with the surface of the applied layer to obtain 3D scan data for modeling and analyzing the shape of the 3D object. Then, the analyzed 3D object is mapped with a pre-selected graphic pattern. The mapped object is irradiated with light with specific wavelengths in the ultraviolet spectrum during or after the mapping to change the color of the photochromic compound that has applied to the 3D object to the desired color, and then a wavelength-cutoff agent that can cut off ultraviolet radiation contained in natural light is coated over it. This allows the photochromic color-changed state to be kept for a predetermined time.

As described above, according to the present invention, it is possible to add a graphic pattern to a 3D object and change the color of that object. The original color can be reversed to undo the generated color by irradiating it with visible light at 450 nm or longer. When one do not want to go back to the original color, the color-changed object is coated with a wavelength-cutoff agent in the visible region of 450 nm or longer. Examples of the 3D objects include, in addition to the car bodies, nails, artificial nails, lips, hair on one's head, eyebrows, beards, eyeglasses, watches, jewelry including rings, bracelets, and necklaces (hereinafter referred to as “jewelry”), bags, shoes, textiles including neckties, scarves, and handkerchiefs, natural and synthetic fibers, motorcycle bodies, wall materials, indoor equipment including pieces of furniture and ornaments, outdoor equipment including signboards, and wall surfaces including ceilings, floors, and side walls of buildings.

Light in the ultraviolet range used in the present invention is classified according to wavelengths into near UV with wavelengths of 380-200 nm, far UV (FUV) or vacuum UV (VUV) with wavelengths of 200-10 nm, and extreme UV (EUV or XUV) with wavelengths of 121-10 nm. From the viewpoint of human health and environmental impact, near UV is sometimes further divided into UVA (400-315 nm), UVB (315-280 nm), and UVC (<280 nm). Unlike the above FUV, deep UV (DUV) in photolithography and laser technology refers to ultraviolet radiation with 300 nm or shorter wavelengths. Sunlight contains ultraviolet radiation with wavelengths of UVA, UVB, and UVC, of which UVA and UVB pass through the ozone layer and reach the earth's surface. UVC, however, is significantly absorbed by materials and cannot normally pass through the atmosphere. UVA accounts for 99% of the UV radiation that reaches the earth's surface (reactions in the ozone layer produces some UVC).

In the present invention, diarylethene, which is applied to the surface of a product, exhibits the three primary colors of cyan, magenta, and yellow simultaneously in response to wavelengths in the ultraviolet spectrum produced by the light-emitting means, producing a black appearance of the product's surface. Then, the colored surface is exposed to light with specific wavelengths in the visible spectrum using the light-emitting means to fade the respective induced three primary colors with the irradiation output and time controlled, thereby to produce the desired color tone.

On the other hand, in the present invention, the diarylethene is coated with a wavelength-cutoff agent that can cut off UVA (400-315 nm), which is abundant in natural light. For this reason, the wavelengths in the ultraviolet spectrum projected from the light-emitting means to the diarylethene comprise specific wavelengths such as UVB (315-280 nm) and UVC (<280 nm), which are minor components of natural light. Here, increasing the output of the light-emitting means can complement the coloration of the maximum density.

In the present invention, the wavelength-cutoff agent that can block UVA, which is abundant in natural light, is used for inducing colors of diarylethene. Thus, the coloration is not affected by the ultraviolet radiation in natural light and only the visible light fades the color. The fading caused by the visible light takes several minutes to several hours.

With the present invention, any induced color can be maintained for a certain time under natural or illumination light, taking advantage of the following features: instantaneous production of black appearance of diarylethene from the three primary colors upon irradiation of wavelengths in the ultraviolet spectrum; color tuning of the black colored surface with light with specific wavelengths in the visible spectrum; and gradual fading caused by the visible light only, which is not affected by ultraviolet radiation, using a wavelength-cutoff agent that cuts off UVA.

### BRIEF DESCRIPTION OF DRAWINGS

FIG. 1 An explanatory diagram schematically illustrating a color-changing method according to the present invention being applied to nails (fingernails, artificial nails).

FIG. 2 An explanatory diagram schematically illustrating how a color-changing method according to the present invention is applied to a car.

FIG. 3 A diagrammatic flow diagram for explaining steps of combining a color-changing method according to the present invention with the mapping of a car body with a graphic pattern.

### DESCRIPTION OF EMBODIMENTS

Next, an embodiment for implementing the method of the present invention is described with reference to the drawings.

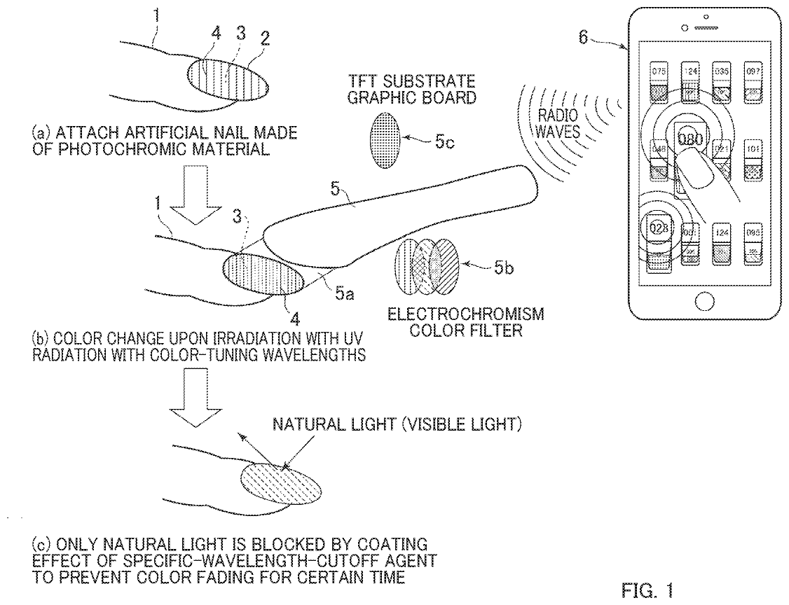

FIG. 1 illustrates the application of the present invention to changing the color of a nail. The reference numerals 1 and 2 represent a human finger and an artificial nail attached to the nail of the finger, respectively. The artificial nail 2 can be either a plastic nail with an organic photochromic compound applied as a photochromic material, or an organic photochromic compound formed into a nail shape.

The artificial nail 2 in the step (a) in FIG. 1 has a photochromic material 3 coated with a wavelength-cutoff agent 4 that cuts off specific wavelengths in the ultraviolet spectrum. In the next step (b), the artificial nail 2 attached to the nail of the finger 1 is irradiated with light in the ultraviolet range 5a, which is different from the specific wavelengths, from a light-emitting means 5. In FIG. 1, the reference numeral 6 represents a light source control unit that chooses a plurality of specific wavelengths in the ultraviolet spectrum emitted from the light-emitting means 5, with association to the colors intended to be induced, and wirelessly supplies a control signal to the light-emitting means to instruct emission of the chosen specific wavelengths. As an example, the color of the artificial nail 2 can be developed as (changed to) the desired color by exposing it to light at 370 nm, 380 nm, or 405 nm when the desired color is red, yellow, or blue, respectively.

For the coating of the wavelength-cutoff agent 4, which cuts off wavelengths in the ultraviolet spectrum other than the aforementioned irradiated wavelengths, the wavelength-cutoff agent 4 can be coated after irradiating the photochromic material 3 with light with wavelengths for inducing the desired color from the light-emitting means 5 to turn the photochromic material 3 into the desired color. The timing of the coating of the wavelength-cutoff agent 4 in the following examples is the same as in the above example in that it can be after the color of the photochromic material 3 has been changed. For the above wavelength-cutoff agent 4, the wavelengths to be cut off are 400 nm to 280 nm contained in natural light, and preferably at least 400 nm to 315 nm. The term “ultraviolet radiation” and “ultraviolet wavelength” are interchangeably used herein with wavelengths in the ultraviolet spectrum.

The light-emitting means 5 in FIG. 1 has a battery as a power source, a lamp as a light source, and a control board inside. In the case where the photochromic material 4 is an inorganic one that changes its color to the color of the irradiated light, a color filter is placed in front of the light source. In the case where a picture or other graphic is projected on the artificial nail 2, a graphic board made of liquid crystal or other material is placed in front of the light source.

The photochromic material 3 of the artificial nail 2 changes, upon irradiation with the light with specific wavelengths 5a, its color to a color of wavelengths in the visible spectrum corresponding to the irradiated specific wavelengths. For the generated color, the surface of the photochromic material 3 is coated with a wavelength-cutoff agent 4 that can cut off ultraviolet radiation of natural light. Thus, the ultraviolet radiation is cut off and the generated color does not fade for a certain time (see the step (c)).

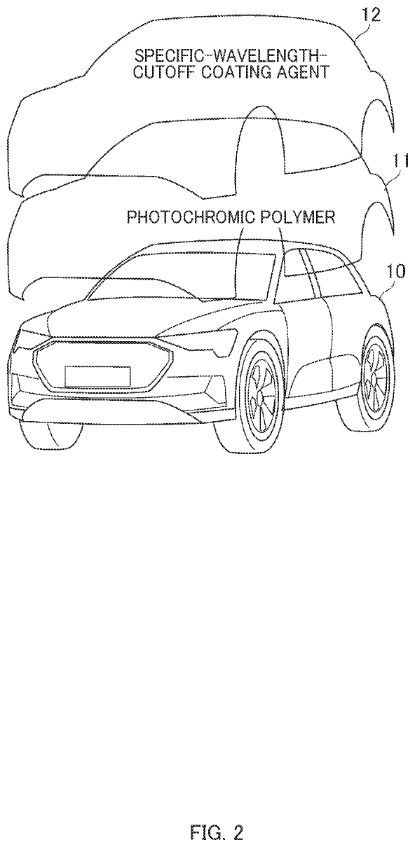

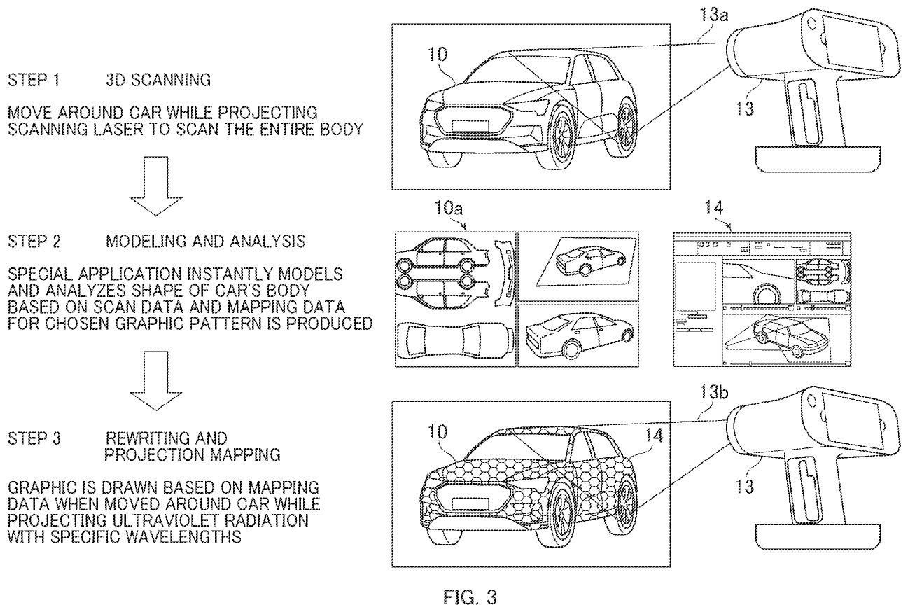

Next, an example in which the color-changing method of the present invention is applied in combination with mapping of a car body with a graphic pattern is described with reference to FIGS. 2 and 3.

FIG. 2 shows a conceptual diagram illustrating a case where the color-changing method of the present invention is applied to a car body. In FIG. 2, a photochromic material 11 is applied to a car body 10. For this purpose, used is a specially-adapted handheld device (hereinafter referred to as a “rewritable booster 13”) with 3D scanning and projection mapping functions which emits light with specific wavelengths that change the color of and/or patterns on an object (the body 10). This allows instant changing of the color and/or a graphic design of the car body 10 according to the scene, season, or mood of the day and reduction of an overwhelming amount of time and cost compared to conventional painting or wrapping to provide significant user benefits. Referring to FIG. 3, the above example is described in order of performing process steps. It should be noted that a UV wavelength-cutoff agent 12 is coated after the color of the photochromic material 11 has been changed by light irradiation with the rewritable booster 13.

In the step 1, the car body 10 is scanned in 3D. Specifically, the rewritable booster 13 moves all around the car to scan the entire car body 10 while projecting a scanning laser 13a onto the car body 10.

In the step 2, the shape of the car body 10 is instantly modeled and analyzed 10a using a special application software based on the scan data obtained in the step 1, and mapping data 13b for a pre-selected graphic pattern 14 is produced.

In the step 3, the rewritable booster 13 moves all around the car while projecting light with specific wavelengths in the ultraviolet spectrum to the car body 10 and projects the mapping data 13b generated in the step 2 onto the car body 10. As a result, the photochromic material 11 on the surface of the car body 10 changes to a specific color, and the graphic pattern 14 based on the mapping data 13b is drawn (mapped) on the car body 10.

As described above, the present invention makes it possible to change the color of the car body 10 to the desired color and map it with the desired graphic pattern simultaneously, allowing significant reduction of the time and effort required for painting car bodies or mapping them with graphics using conventional methods.

Not only car users but also car dealers can enjoy the aforementioned advantages. This is because a single car can be displayed in multiple colors and graphics by applying the method of the present invention to cars to be displayed in a shop.

The present invention described above can be applied to the following as an object: nails, artificial nails, lips, hair on one's body including hair on one's head, eyeglasses, watches, jewelry including rings, bracelets, and necklaces, bags, shoes, textiles including neckties, scarves, and handkerchiefs, natural and synthetic fibers, bodies of vehicles including motorcycles and cars, wall materials, indoor equipment including pieces of furniture and ornaments, outdoor equipment including signboards, and wall surfaces including ceilings, floors, and side walls of buildings.

### REFERENCE SIGNS LIST

1 finger
2 artificial nail
3 photochromic material
4 wavelength-cutoff agent
5 light-emitting means
6 light source control unit

1. A method of changing a color of a surface-forming portion comprising:
depositing a photochromic substance on a surface-forming portion of an object; and
applying a wavelength-cutoff agent to a surface of the deposited photochromic substance in changing a color of the photochromic substance by photochromism by irradiating the surface of the deposited photochromic substance with light in an ultraviolet range, before the irradiation of the light in the ultraviolet range, the wavelength-cutoff agent blocking light with a wavelength in an ultraviolet spectrum contained in natural light and/or illumination light.

2. A method of changing a color of a surface-forming portion comprising:
depositing a photochromic substance on a surface-forming portion of an object; and
applying a wavelength-cutoff agent to the surface of the deposited photochromic substance in changing a color of the photochromic substance by photochromism by irradiating the surface of the deposited photochromic substance with light in an ultraviolet range, after the color of the photochromic substance has been changed by the irradiation with the light in the ultraviolet range, the wavelength-cutoff agent blocking a wavelength in an ultraviolet spectrum contained in natural light and/or illumination light.

3. The method according to claim 1, wherein the wavelength-cutoff agent is applied on the photochromic substance so that the amount of light with wavelengths blocked by the wavelength-cutoff agent is kept for a certain time.

4. The method according to claim 1, wherein wavelengths in the ultraviolet spectrum to be cut off by the wavelength-cutoff agent are 400 nm to 280 nm, preferably 400 nm to 315 nm.

5. The method according to claim 1, wherein the surface-forming portion whose color has been changed by photochromism returns to an original color of the surface-forming portion upon irradiation with light in a visible range.

6. The method according to claim 1, wherein the photochromic substance deposited on the surface-forming portion is an organic photochromic compound that turns, upon irradiation with light with specific wavelengths in an ultraviolet spectrum, to a color in a visible region corresponding to the irradiated specific wavelengths.

7. The method according to claim 6, wherein the organic photochromic compound is a single-crystal diarylethene comprising three organic molecules having different structures.

8. The method according to claim 1, wherein the surface-forming portion of the object is that of any one of nails, artificial nails, lips, hair on one's body including hair on one's head, eyeglasses, watches, jewelry including rings, bracelets, and necklaces, bags, shoes, textiles including neckties, scarves, and handkerchiefs, natural and synthetic fibers, bodies of vehicles including motorcycles and cars, wall materials, indoor equipment including pieces of furniture and ornaments, outdoor equipment including signboards, and wall surfaces including ceilings, floors, and side walls of buildings.

9. A system for changing a color of a surface-forming portion comprising:
a surface-forming portion of an object, a photochromic substance deposited on the surface-forming portion;
light-emitting means configured to emit light in an ultraviolet range; and
application means applying a wavelength-cutoff agent to the surface-forming portion on which the photochromic substance has been deposited, by driving the wavelength-cutoff agent before the light-emitting means is driven, the wavelength-cutoff agent blocking a specific wavelength in an ultraviolet spectrum to the surface-forming portion on which the photochromic substance has been deposited, wherein
the light in the ultraviolet range is projected from the light-emitting means onto the surface-forming portion to cause the photochromic substance to induce photochromism and change a color of the surface-forming portion.

10. A system for changing a color of a surface-forming portion comprising:
a surface-forming portion with a photochromic substance deposited on a surface-forming portion of an object;
light-emitting means configured to emit light in an ultraviolet range; and
application means applying a wavelength-cutoff agent to the surface-forming portion after the light-emitting means has been driven and the photochromic substance has undergone a change in color by photochromism, the wavelength-cutoff agent blocking a specific wavelength in an ultraviolet spectrum to the surface-forming portion on which the photochromic substance has been deposited, wherein
the light in the ultraviolet range is projected from the light-emitting means onto the surface-forming portion to cause the photochromic substance to induce photochromism and change a color of the surface-forming portion.

11. The system according to claim 9, wherein the photochromic substance is an organic photochromic compound that changes its color, upon irradiation with light with specific wavelengths in an ultraviolet spectrum, to a color in a visible region corresponding to the irradiated specific wavelengths, and reverts to its original color upon irradiation with light in a visible range.

12. The system according to claim 9, wherein the surface-forming portion is that of any one of nails, artificial nails, lips, hair on one's body including hair on one's head, eyeglasses, watches, jewelry including rings, bracelets, and necklaces, bags, shoes, textiles including neckties, scarves, and handkerchiefs, natural and synthetic fibers, bodies of vehicles including motorcycles and cars, wall materials, indoor equipment including pieces of furniture and ornaments, outdoor equipment including signboards, and wall surfaces including ceilings, floors, and side walls of buildings.

13. The system according to claim 9, wherein the light-emitting means can emit light with specific wavelengths in a region between ultraviolet and infrared.

14. The system according to claim 9, wherein the wavelength-cutoff agent allows tuning of wavelengths to be cut off in 20 nm increments and cutting them off.

15. A method of changing a color of an object by adding a graphic pattern to a three-dimensional object, comprising:
applying a photochromic compound to a surface of a three-dimensional object such as a car body;
scanning the object with a 3D scanner to obtain 3D scan data and modeling and analyzing an object's shape;
mapping the analyzed object with a pre-selected graphic pattern;
irradiating the mapped object with light with specific wavelengths in an ultraviolet spectrum to change a color of the photochromic compound applied to the object, during or after the mapping; and
coating the object with a wavelength-cutoff agent that cuts off wavelengths in an ultraviolet spectrum, after irradiating the mapped object with light with specific wavelengths in an ultraviolet spectrum to change a color of the photochromic compound that has been applied to the object, during or after the mapping.

16. A method of changing a color of an object by adding a graphic pattern to a three-dimensional object, comprising:
applying a photochromic compound to a surface of a three-dimensional object such as a car body;
scanning the object with a 3D scanner to obtain 3D scan data and modeling and analyzing an object's shape;
mapping the analyzed object with a pre-selected graphic pattern; and
coating the object with a wavelength-cutoff agent that cuts off wavelengths in an ultraviolet spectrum before the photochromic compound undergoes a change in color, when the mapped object is irradiated with light with specific wavelengths in an ultraviolet spectrum to change a color of the photochromic compound that has been applied to the object, during or after the mapping.

17. The method according to claim 15, wherein the three-dimensional object is a nail, an artificial nail, a lip, hair on one's body including hair on one's head, eyeglasses, a watch, jewelry including a ring, a bracelet, and a necklace, a bag, shoes, a textile including a necktie, a scarf, and a handkerchief, a natural or synthetic fiber, a body of a vehicle including a motorcycle and a car, a wall material, indoor equipment including a piece of furniture and an ornament, outdoor equipment including a signboard, and a wall surface including a ceiling, a floor, and a side wall of a building.
